(19) United States
(12) Patent Application Publication
(10) Pub. No.: US 2018/0306981 A1
(43) Pub. Date: Oct. 25, 2018

(54) OPTICAL SUB-MODULE

(71) Applicant: FOXCONN INTERCONNECT TECHNOLOGY LIMITED, Grand Cayman (KY)

(72) Inventor: KHOR WOOI QUAN, Singapore (SG)

(21) Appl. No.: 15/959,312

(22) Filed: Apr. 23, 2018

(30) Foreign Application Priority Data
Apr. 21, 2017 (CN) 201720429318.0

(51) Int. Cl. G02B 6/38; B24B 19/22

(52) U.S. Cl. CPC G02B 6/3863; B24B 19/226; G02B 6/3854; G02B 6/3822

(57) ABSTRACT

An optical sub-module comprises a lens and a optical fiber ferrule assembled with the lens, the lens comprises a receiving hole receiving the optical fiber ferrule; wherein the optical fiber ferrule includes a mating surface mating with the lens and a refractive index matching epoxy disposed on the mating surface for reducing optical return loss, and the mating surface has an APC-type end.

### BACKGROUND OF THE INVENTION

### 1. Field of the Invention

The present disclosure relates to an optical sub-module with a short fiber ferrule.

### 2. Description of Related Arts

Referring to FIGS. 1 to 3, an optical sub-module 100 includes a lens 1 and a short fiber ferrule 2 assembled with the lens 1. A mating surface 21 of the short fiber ferrule 2 is a PC (Physical Contact) type end of a spherical surface. As the speed of optical transmission is getting higher and higher, such optical sub module is used. FIG. 3 shows an optical return loss analysis, wherein the first line 400 is the optical return loss curve of the lens 1, the second line 500 is the optical return loss curve of the optical sub-module 100, and the optical return loss dB value of a large area is located below the standard 26 dB. The smaller the value of the optical return loss dB is, the greater the optical return loss is, so the product yield in FIG. 3 is very low. In order to increase the dB value of the optical return loss and reduce the optical return loss, an anti-reflection layer is usually provided on the PC type end surface. However, increasing the anti-reflection layer cannot reduce the loss to a large enough extent and cannot improve the yield in a large area. Rather, adding an anti-reflection layer greatly increases production costs.

An improved optical sub-module reducing the loss of light echo to improve product yield is desired.

### SUMMARY OF THE INVENTION

Accordingly, an object of the present invention is to provide an optical sub-module with low optical return loss.

To achieve the above object, an optical sub-module comprises a lens and a optical fiber ferrule assembled with the lens, the lens comprises a receiving hole receiving the optical fiber ferrule; wherein the optical fiber ferrule includes a mating surface mating with the lens and a refractive index matching epoxy disposed on the mating surface for reducing optical return loss, and the mating surface has an APC-type end.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an optical sub-module in current technology;

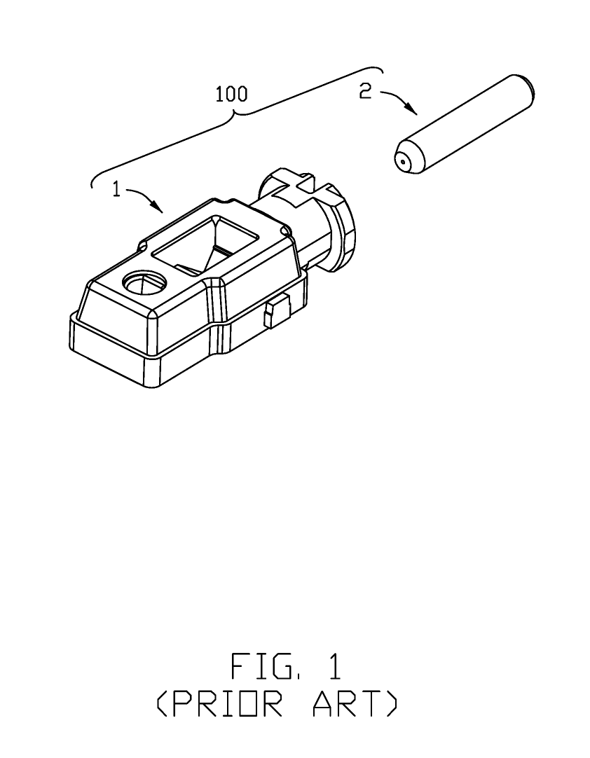

FIG. 2 is a cross-sectional view of an optical sub-module in current technology;

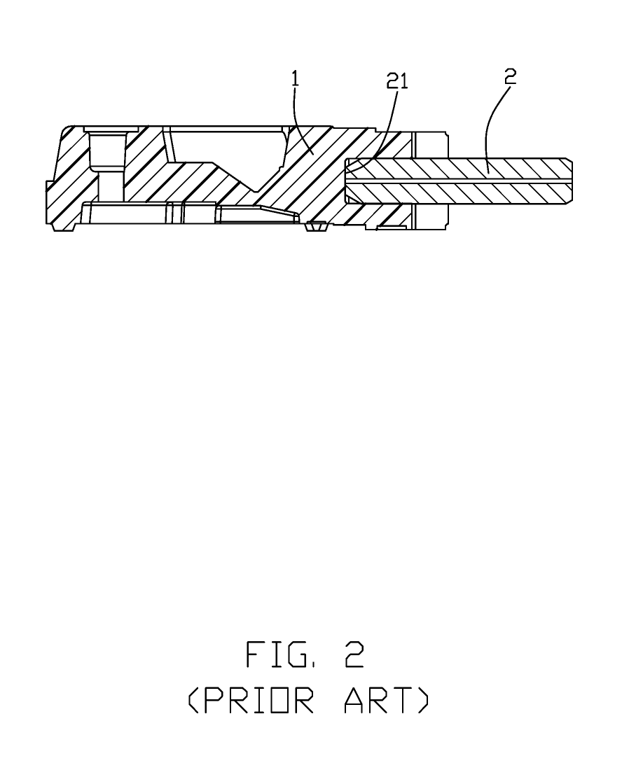

FIG. 3 is return loss analysis chart of the optical sub-module as shown in FIG. 2;

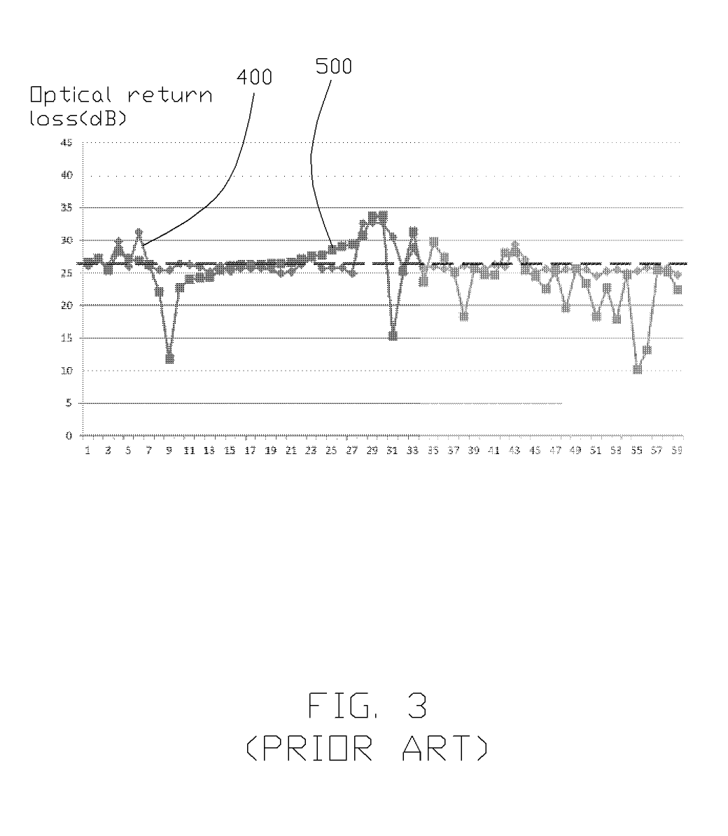

FIG. 4 is a perspective view of the optical sub-module in the present invention;

FIG. 5 is an exploded view of a first embodiment of the optical sub-module in the present invention;

FIG. 6 is another exploded view of the optical sub-module;

FIG. 7 is a cross-sectional view of the first embodiment optical sub-module taken along line 7-7 in FIG. 4;

FIG. 8 is a side view of a short fiber ferrule of the optical sub-module;

FIG. 9 is a cross-sectional view of a second embodiment optical sub-module;

FIG. 10 is a side view of a short fiber ferrule of the second embodiment optical sub-module shown in FIG. 9; and

FIG. 11 is return loss analysis chart of the optical sub-module as shown in FIG. 4.

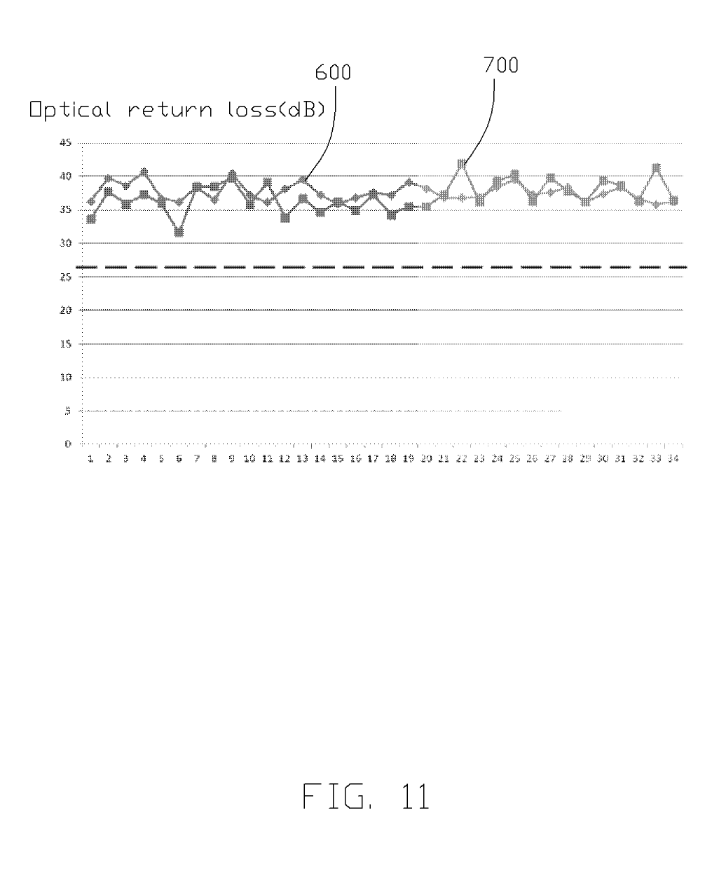

### DETAILED DESCRIPTION OF THE PREFERRED EMBODIMENT

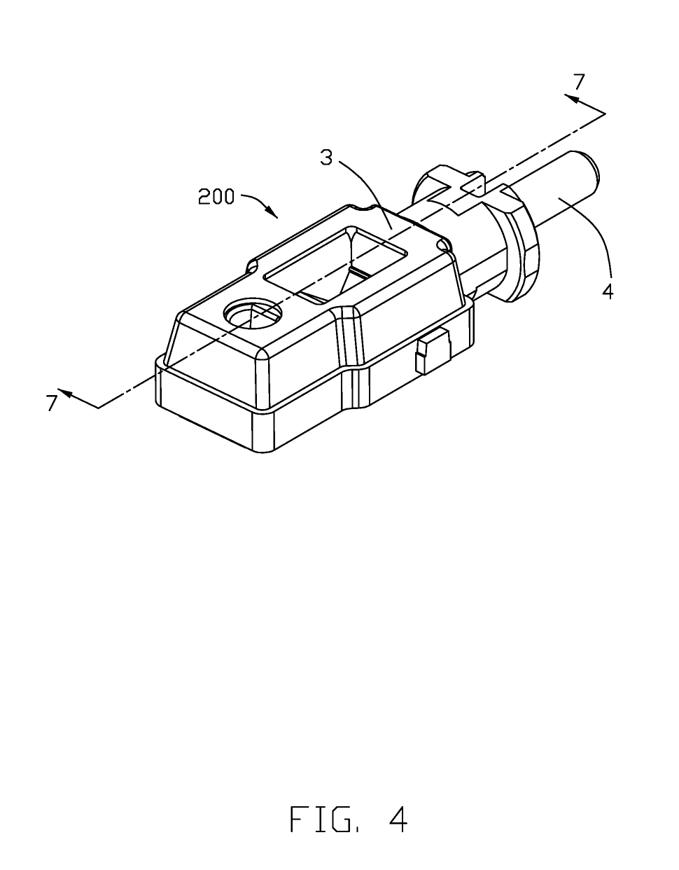

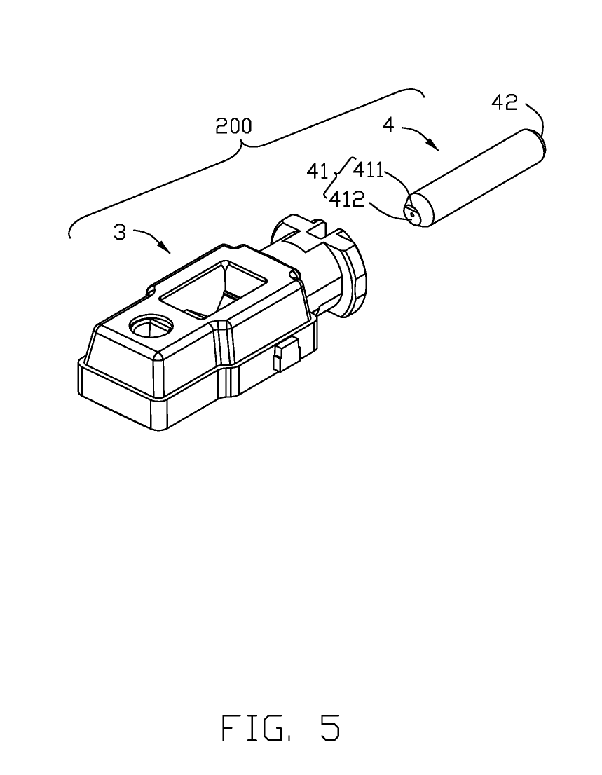

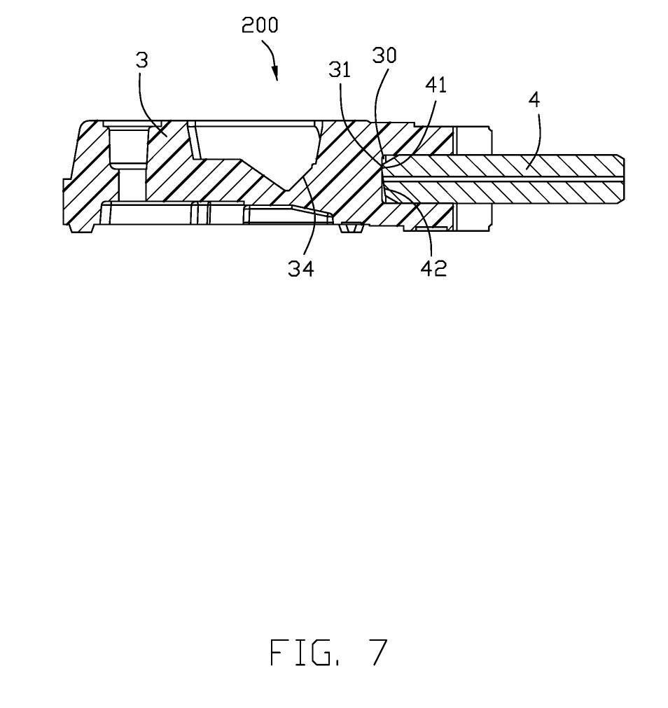

FIGS. 4-7 show a first embodiment of the present invention. An optical sub-module 200 is used to couple an optical transmission medium and an optoelectronic module. The optical sub-module 200 includes a lens 3 and a short optical fiber ferrule 4, with the associated axially extending inner fiber (not labeled), assembled with the lens 3.

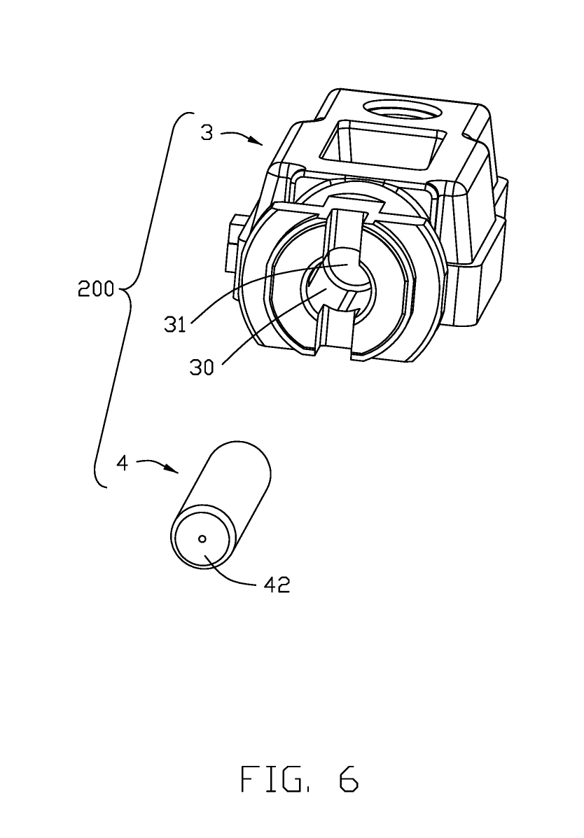

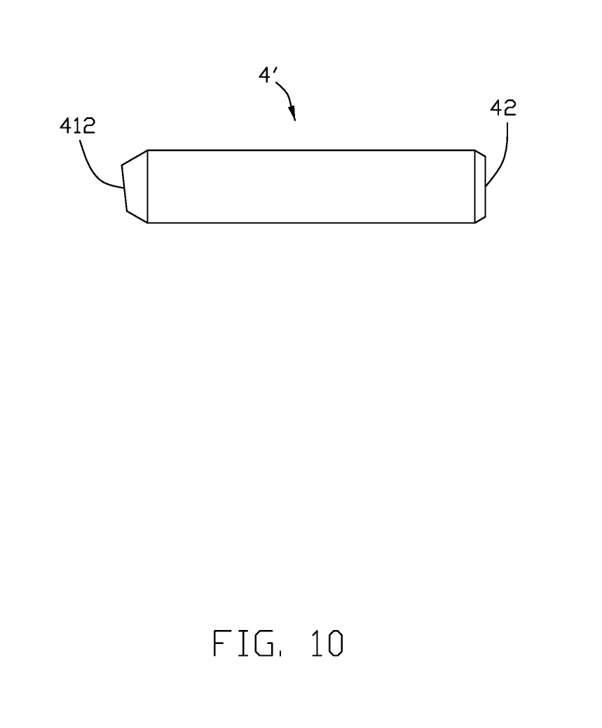

The lens 3 includes a reflective surface 34, a horizontally extending cylindrical receiving hole 30 receiving the short optical fiber ferrule 4 and a bottom/end surface 31 located on the bottom/end of the receiving hole 30 and mating with the short optical fiber ferrule 4. The reflective surface 34 is used for reflecting input light onto a photodiode (not shown). The short optical fiber ferrule 4 includes a mating surface 41 mating with the lens 3 and the other surface 42 far away from the lens 3. The mating surface 41 includes a mating end 411 mating with the bottom surface 31 and an APC (Angled-Physical Contact) type end 412 connecting with the mating end 411. The APC-type end 412 is a beveled spherical end surface. When the short fiber ferrule 4 and the lens 3 are assembled, the mating end 411 and the bottom surface 31 are parallel or substantially parallel surfaces, so that the mating end 411 and the bottom surface 31 are butted against each other to form a reference surface for positioning the APC-type end 412. In this embodiment, the APC-type end 412 preferably has a grinding angle range of 4° to 45°, and when the grinding angle is 8°, the optical return loss is the lowest. FIG. 10 is return loss analysis chart of the optical sub-module 200 as shown in FIG. 6. The third line 600 is the optical return loss curve of the lens 3, and the fourth line 700 is the optical return loss curve of the optical sub-module 200. Referring to FIG. 10, most of the optical return loss of optical sub-module 200 values greater than 37 dB, 100% beyond the standard 26 dB requirements, product yield greatly improved. In this embodiment, the other surface is PC-type end. In other embodiments, the other surface 42 may also be provided as another APC-type end according to actual needs. In this embodiment, the mating surface 41 is provided with a mating end 411 parallel or substantially parallel to the bottom surface 31 so that the mating end 411 and the bottom surface 31 can form a mating datum surface when the short optical fiber ferrule 4 is docked with the lens 3. While the effect of reducing the optical return loss is achieved by providing the APC-type end 412 connected to the mating end 411. In this embodiment, the short optical fiber ferrule 4 may further be provided with a refractive index matching epoxy resin (not shown) disposed on the mating surface 41, and a refractive index matching epoxy resin is coated on the mating surface 41 to reduce the light return loss.

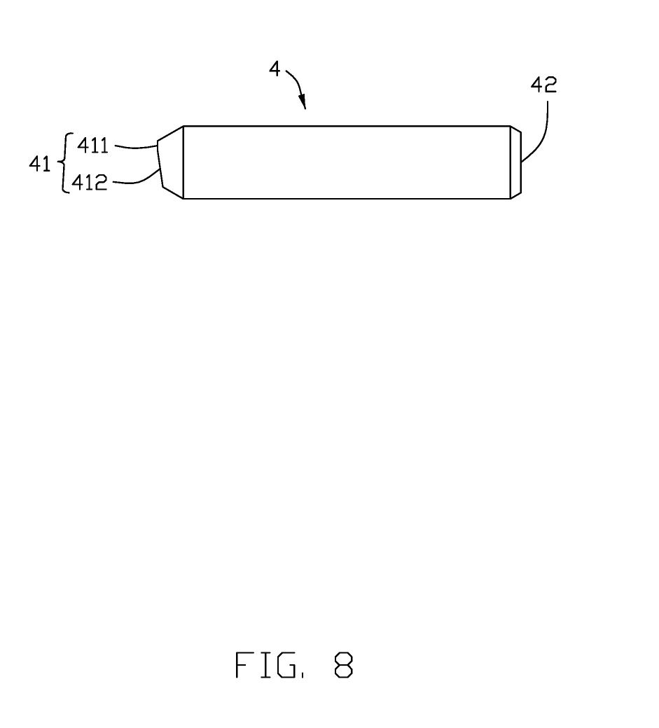

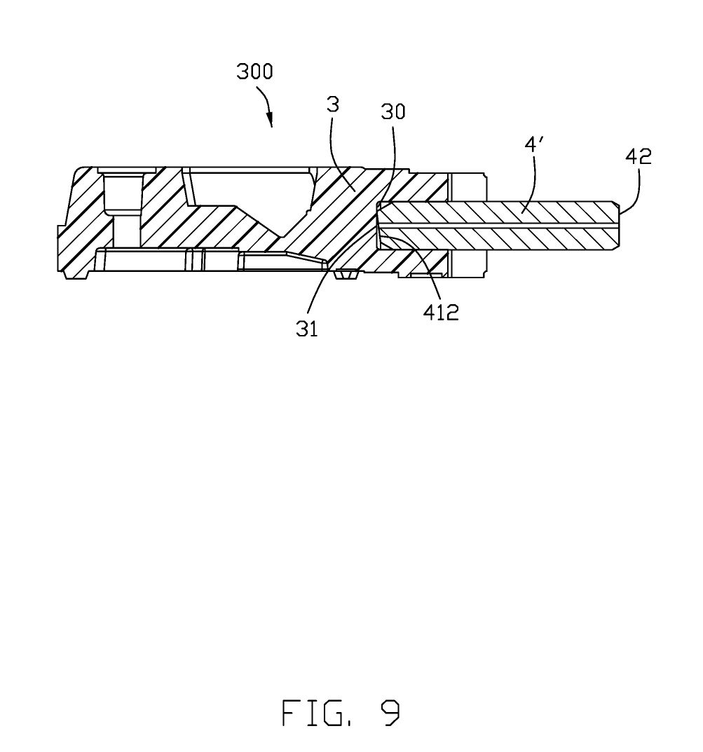

The first embodiment is only a preferred embodiment of the present invention. In other embodiments, the mating surface only needs to be provided with the APC-type end, which is not limited to the structure of the first embodiment. For example, the mating end 411 is not provided, or other additional end can be added. For example, FIGS. 8-9 show a second embodiment in the present invention. An optical sub-module 300 includes a lens 3 and a short optical fiber ferrule 4′ assembled with the lens 3. The short optical fiber ferrule 4′ includes a mating surface 41 mating with the lens 3 and the other surface 42 far away from the lens 3. Wherein, the mating surface 41 only includes the APC-type end 412. In this embodiment, the APC-type end 412 also greatly improves the return loss, satisfying the yield requirement. Notably, the short fiber ferrule 4, 4′ essentially forms, around the mating/coupling section (not labeled), a truncated right circular cone structure with the obliquely extending head (not labeled) on which the angled mating surface end 412 is located so as to have such right circular cone extends asymmetrically in a side view.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An optical sub-module comprising:
a lens comprising a receiving hole receiving the optical fiber ferrule; and
an optical fiber ferrule assembled with the lens; wherein
the optical fiber ferrule includes a mating surface mating with the lens and a refractive index matching epoxy disposed on the mating surface for reducing optical return loss, and the mating surface has an APC(Angled physical contact)-type end.

2. The optical sub-module as claimed in claim 1, wherein the lens includes a bottom surface located on the bottom of the receiving hole and mating with the optical fiber ferrule.

3. The optical sub-module as claimed in claim 2, wherein the mating surface includes a mating end mating with the bottom surface.

4. The optical sub-module as claimed in claim 3, wherein the mating end is parallel to the bottom surface.

5. The optical sub-module as claimed in claim 3, wherein the mating end connects with the APC-type end and is located on the top of the APC-type end.

6. The optical sub-module as claimed in claim 1, wherein the APC-type end is spherical with a certain angle.

7. The optical sub-module as claimed in claim 6, wherein the APC-type end has a grinding angle range of 4° to 45°.

8. The optical sub-module as claimed in claim 6, wherein the grinding angle of the APC-type is 8°.

9. The optical sub-module as claimed in claim 1, wherein the optical fiber ferrule includes a surface distal from the lens, the surface having a PC-type end.

10. The optical sub-module as claimed in claim 1, wherein the lens further includes a reflective surface for emitting light.

11. An optical sub-module comprising:
a lens forming a horizontally extending cylindrical receiving hole with an end surface at an end of said receiving hole, and a reflecting surface essentially aligned horizontally with the end surface; and
an optical fiber ferrule snugly assembled within the receiving hole; wherein the optical fiber ferrule includes a mating surface coupling to the end surface, and a refractive index matching epoxy disposed on the mating surface for reducing optical return loss; wherein
the mating surface is primarily angled with an axial direction of the receiving hole.

12. The optical sub-module as claimed in claim 11, wherein said mating surface further includes a minor mating end parallel to the end surface intimately contacting said end surface.

13. The optical sub-module as claimed in claim 11, wherein the mating surface extends in a grinding angle range of 4° to 45°.

14. The optical sub-module as claimed in claim 11, wherein the mating surface extends at 8°.

15. The optical sub-module as claimed in claim 11, wherein the optical fiber ferrule around a mating section thereof, forms a truncated right circular cone structure with an obliquely extending head on which the angled mating surface end is located so as to have said truncated right circular cone extend asymmetrically in a side view.

16. The optical sub-module as claimed in claim 15, wherein the end surface is perpendicular to said axial direction of the receiving hole.
